(19) United States
(12) Patent Application Publication
(10) Pub. No.: US 2017/0344374 A1
(43) Pub. Date: Nov. 30, 2017

(54) PROCESSOR WITH EFFICIENT REORDER BUFFER (ROB) MANAGEMENT

(71) Applicant: Centipede Semi Ltd., Netanya (IL)

(72) Inventors: Jonathan Friedmann, Even Yehuda (IL); Shay Koren, Tel-Aviv (IL)

(21) Appl. No.: 15/603,505

(22) Filed: May 24, 2017

Related U.S. Application Data
(60) Provisional application No. 62/341,654, filed on May 26, 2016.

(51) Int. Cl. G06F 9/30; G06F 9/38

(52) U.S. Cl. CPC G06F 9/30058; G06F 9/3867

(57) ABSTRACT

A method includes, in a pipeline of a processor, writing instructions of a single software thread that are pending for execution into a reorder buffer (ROB) in accordance with a single write position, and incrementing the single write position to point to a location in the ROB for a next instruction to be written. The instructions, which were written in accordance with the single write position, are removed from first and second different locations in the ROB, and the first and second locations are incremented.

### CROSS-REFERENCE TO RELATED APPLICATIONS

This application claims the benefit of U.S. Provisional Patent Application 62/341,654, filed May 26, 2016, whose disclosure is incorporated herein by reference.

### FIELD OF THE INVENTION

The present invention relates generally to processor design, and particularly to methods and apparatus for Reorder Buffer (ROB) management.

### BACKGROUND OF THE INVENTION

In most pipelined microprocessor architectures, one of the final stages in the pipeline is committing of instructions. Various committing techniques are known in the art. For example, Cristal et al. describe processor microarchitectures that allow for committing instructions out-of-order, in “Out-of-Order Commit Processors,” IEE Proceedings-Software, February, 2004, pages 48-59.

Ubal et al. evaluate the impact of retiring instructions out of order on different multithreaded architectures and different instruction-fetch policies, in “The Impact of Out-of-Order Commit in Coarse-Grain, Fine-Grain and Simultaneous Multithreaded Architectures,” IEEE International Symposium on Parallel and Distributed Processing, April, 2008, pages 1-11.

Some suggested techniques enable out-of-order committing of instructions using checkpoints. Checkpoint-based schemes are described, for example, by Akkary et al., in “Checkpoint Processing and Recovery: Towards Scalable Large Instruction Window Processors,” Proceedings of the 36^{th} International Symposium on Microarchitecture, 2003; and by Akkary et al., in “Checkpoint Processing and Recovery: An Efficient, Scalable Alternative to Reorder Buffers,” IEEE Micro, volume 23, issue 6, November, 2003, Pages 11-19.

Duong and Veidenbaum describe an out-of-order instruction commit mechanism using a compiler/architecture interface, in “Compiler Assisted Out-Of-Order Instruction Commit,” Center for Embedded Computer Systems, University of California, Irvine, CECS Technical Report 10-11, November 18, 2010.

Vijayan et al. describe an architecture that allows instructions to commit out-of-order, and handles the problem of precise exception handling in out-of-order commit, in “Out-Of-Order Commit Logic with Precise Exception Handling for Pipelined Processors,” Poster in High Performance Computer Conference (HiPC), December, 2002.

### SUMMARY OF THE INVENTION

An embodiment of the present invention that is described herein provides a method including, in a pipeline of a processor, writing instructions of a single software thread that are pending for execution into a reorder buffer (ROB) in accordance with a single write position, and incrementing the single write position to point to a location in the ROB for a next instruction to be written. The instructions, which were written in accordance with the single write position, are removed from first and second different locations in the ROB, and the first and second locations are incremented.

In some embodiments, writing the instructions includes storing the instructions in respective memory locations in accordance with a write pointer, incrementing the single write position includes incrementing the write pointer, removing the instructions includes reading the instructions from the first and second locations in the ROB in accordance with respective first and second read pointers, and incrementing the first and second locations includes incrementing the first and second read pointers. In other embodiments, the ROB includes one or more linked-lists, writing the instructions includes writing a new instruction by adding a new linked-list entry to a beginning of the ROB, and removing the instructions includes removing an instruction by removing a respective linked-list entry from the ROB. In an embodiment, removing the instructions includes removing at least some of the instructions speculatively.

In some embodiments, removing the instructions includes creating at least one unoccupied region in the ROB, preceding the second read location. In an embodiment, the method further includes marking one of the buffered instructions in the ROB to point to a beginning of the unoccupied region. In a disclosed embodiment, removing the instructions includes verifying that the unoccupied region does not exceed a predefined maximum size.

In some embodiments, the first and second locations are initially the same, and the method includes advancing the second location in response to a predefined event. In an embodiment, the predefined event includes a stall in removing the instructions from the first location. In another embodiment, the predefined event includes availability of an architectural-to-physical register mapping for an instruction younger than the instruction at the first location.

In some embodiments, removing the instructions includes, in a given cycle, choosing whether to remove an instruction from the first location of from the second location based on a predefined rule. In an embodiment, choosing whether to remove the instruction from the first or the second location includes giving the first location priority in removing the instructions, relative to the second location. In another embodiment, choosing the first or the second location includes giving the second location priority in removing the instructions, relative to the first location.

There is additionally provided, in accordance with an embodiment of the present invention, a processor including a pipeline and control circuitry. The pipeline includes a reorder buffer (ROB). The control circuitry is configured to write instructions of a single software thread that are pending for execution into the ROB in accordance with a write pointer, and increment the write pointer to point to a location in the ROB for a next instruction to be written, and to remove the instructions, which were written in accordance with the same write pointer, from first and second different locations in the ROB in accordance with respective first and second read pointers, and increment the first and second read pointers to track the first and second locations.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a processor, in accordance with an embodiment of the present invention; and

FIG. 2 is a diagram that schematically illustrates a process of ROB management, in accordance with an embodiment of the present invention.

### DETAILED DESCRIPTION OF EMBODIMENTS

### Overview

Embodiments of the present invention that are described herein provide improved methods and apparatus for managing a Reorder Buffer (ROB) in a processor.

In some embodiments, a processor comprises a pipeline, and control circuitry that controls the pipeline. The pipeline typically fetches instructions from memory, decodes and possibly renames them, and then buffers the instructions in the ROB in-order. The buffered instructions are issued, possibly out-of-order, from the ROB for execution by various execution units. When instructions are executed and committed, they are removed from the ROB.

In one possible implementation, the ROB is managed as a cyclic buffer, using a write buffer that tracks the position of the next instruction to be written into the ROB, and a read pointer that tracks the position of the next instruction to be removed. The read pointer is also referred to as “commit pointer” or “retire pointer,” and all three terms are used interchangeably herein.

In some practical scenarios, such management of the ROB is highly suboptimal and may cause performance bottlenecks. Consider, for example, a scenario in which many of the buffered instructions have already been executed and committed, but a single older instruction is not committed yet. If removal of instructions from the ROB is performed strictly in-order, this single instruction will prevent all other instructions from being removed. As a result, ROB memory space cannot be freed, even though the vast majority of the buffered instructions have already been committed. Other resources, e.g., physical registers and register maps, cannot be released either until the old, long-latency instruction is committed. This long latency instruction may eventually lead to stalling of the entire processor pipeline, and cause significant performance degradation.

The embodiments described herein overcome the above challenges by enabling removal of instructions of a single software thread from multiple locations in the ROB, not only from a single location as with a single read pointer. In some embodiments, the control circuitry manages the ROB using multiple read pointers corresponding to the same write pointer.

In an embodiment, the control circuitry removes instructions from first and second different locations in the ROB in accordance with respective first and second read pointers, speculatively commits the instructions, and increments the first and second read pointers to track the first and second locations. Typically, both the instructions removed in accordance with the first read pointer, and the instructions removed in accordance with the second read pointer, belong to the same single software thread.

When instructions are removed using two separate read pointers, an unoccupied region (also referred to herein as “hole”) develops in the ROB. The terms “hole” and “unoccupied region” do not mean that this region necessarily remains unoccupied. For example, in some embodiments the memory space within the hole can be used for buffering newly-renamed instructions. In other embodiments, the hole is left unoccupied, but does enable releasing of physical resources such as registers and register maps. In some embodiments, more than two read pointers may be used for the same write pointer, resulting in multiple holes.

Without loss of generality, assume that the first read pointer points to older instructions than the second read pointer. Typically, the instructions removed from the ROB in accordance with the second read pointer are removed speculatively, since these instructions have only been committed speculatively. Until these instructions finally become the oldest in the ROB, and committed non-speculatively, there is some probability of flushing them, e.g., in response to some preceding branch misprediction.

In summary, the methods and devices described herein manage the ROB efficiently, and enable efficient usage of memory and other physical resources of the processor. Since the disclosed techniques allow for out-of-order, speculative removal of instructions from the ROB, the impact of long-latency instructions on the average performance of the pipeline is reduced.

The disclosed instruction writing and removal process is described in detail below, including various possible events and scenarios. Additional features, such as criteria for controlling the hole size and for deciding which read pointer to increment, are also described.

### System Description

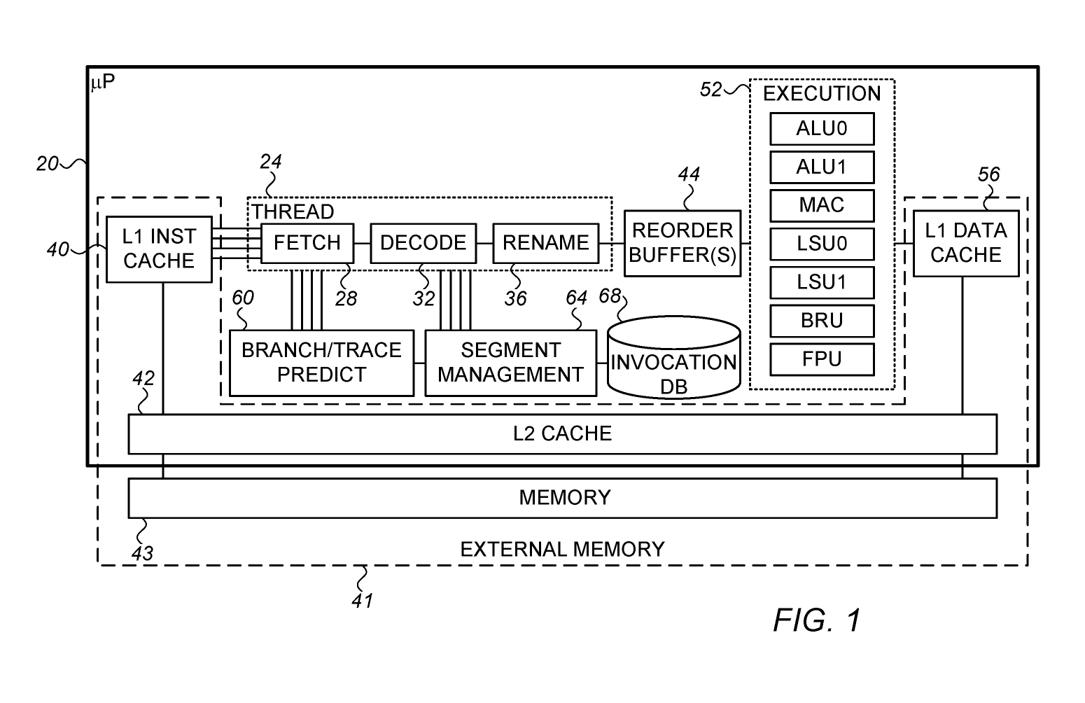

FIG. 1 is a block diagram that schematically illustrates a processor 20, in accordance with an embodiment of the present invention. In the present example, processor 20 comprises a hardware thread 24 that is configured to process multiple code segments in parallel using techniques that are described in detail below. In alternative embodiments, processor 20 may comprise multiple threads 24. Certain aspects of code parallelization are addressed, for example, in U.S. patent application Ser. Nos. 14/578,516, 14/578,518, 14/583,119, 14/637,418, 14/673,884, 14/673,889, 14/690,424, 14/794,835, 14/924,833, 14/960,385, 15/077,936, 15/196,071 and 15/393,291, which are all assigned to the assignee of the present patent application and whose disclosures are incorporated herein by reference.

In the present embodiment, thread 24 comprises one or more fetching modules 28, one or more decoding modules 32 and one or more renaming modules 36 (also referred to as fetch units, decoding units and renaming units, respectively).

Fetching modules 28 fetch instructions of program code from a memory, e.g., from a multi-level instruction cache. In the present example, processor 20 comprises a memory system 41 for storing instructions and data. Memory system 41 comprises a multi-level instruction cache comprising a Level-1 (L1) instruction cache 40 and a Level-2 (L2) cache 42 that cache instructions stored in a memory 43. Decoding modules 32 decode the fetched instructions.

Renaming modules 36 carry out register renaming. The decoded instructions provided by decoding modules 32 are typically specified in terms of architectural registers of the processor's instruction set architecture. Processor 20 comprises a register file that comprises multiple physical registers. The renaming modules associate each architectural register in the decoded instructions to a respective physical register in the register file (typically allocates new physical registers for destination registers, and maps operands to existing physical registers).

The renamed instructions (e.g., the micro-ops/instructions output by renaming modules 36) are buffered in-order in a Reorder Buffer (ROB) 44, also referred to as an Out-of-Order (OOO) buffer. The buffered instructions are pending for out-of-order execution by multiple execution modules 52, i.e., not in the order in which they have been fetched.

The renamed instructions buffered in ROB 44 are scheduled for execution by the various execution units 52. Instruction parallelization is typically achieved by issuing one or multiple (possibly out of order) renamed instructions/micro-ops to the various execution units at the same time. In the present example, execution units 52 comprise two Arithmetic Logic Units (ALU) denoted ALU0 and ALU1, a Multiply-Accumulate (MAC) unit, two Load-Store Units (LSU) denoted LSU0 and LSU1, a Branch execution Unit (BRU) and a Floating-Point Unit (FPU). In alternative embodiments, execution units 52 may comprise any other suitable types of execution units, and/or any other suitable number of execution units of each type. The cascaded structure of threads 24 (including fetch modules 28, decoding modules 32 and renaming modules 36), ROB 44 and execution units 52 is referred to herein as the pipeline of processor 20.

The results produced by execution units 52 are saved in the register file, and/or stored in memory system 41. In some embodiments the memory system comprises a multi-level data cache that mediates between execution units 52 and memory 43. In the present example, the multi-level data cache comprises a Level-1 (L1) data cache 56 and L2 cache 42.

In some embodiments, the Load-Store Units (LSU) of processor 20 store data in memory system 41 when executing store instructions, and retrieve data from memory system 41 when executing load instructions. The data storage and/or retrieval operations may use the data cache (e.g., L1 cache 56 and L2 cache 42) for reducing memory access latency. In some embodiments, high-level cache (e.g., L2 cache) may be implemented, for example, as separate memory areas in the same physical memory, or simply share the same memory without fixed pre-allocation.

A branch/trace prediction module 60 predicts branches or flow-control traces (multiple branches in a single prediction), referred to herein as “traces” for brevity, that are expected to be traversed by the program code during execution by the various threads 24. Based on the predictions, branch/trace prediction module 60 instructs fetching modules 28 which new instructions are to be fetched from memory. Typically, the code is divided into regions that are referred to as segments; each segment comprises a plurality of instructions; and the first instruction of a given segment is the instruction that immediately follows the last instruction of the previous segment. Branch/trace prediction in this context may predict entire traces for segments or for portions of segments, or predict the outcome of individual branch instructions.

In some embodiments, processor 20 comprises a segment management module 64. Module 64 monitors the instructions that are being processed by the pipeline of processor 20, and constructs an invocation data structure, also referred to as an invocation database 68. Invocation database 68 divides the program code into portions, and specifies the flow-control traces for these portions and the relationships between them. Module 64 uses invocation database 68 for choosing segments of instructions to be processed, and instructing the pipeline to process them. Database 68 is typically stored in a suitable internal memory of the processor.

The configuration of processor 20 shown in FIG. 1 is an example configuration that is chosen purely for the sake of conceptual clarity. In alternative embodiments, any other suitable processor configuration can be used. For example, parallelization can be performed in any other suitable manner, or may be omitted altogether. The processor may be implemented without cache or with a different cache structure. The processor may comprise additional elements not shown in the figure. Further alternatively, the disclosed techniques can be carried out with processors having any other suitable micro-architecture. As another example, it is not mandatory that the processor perform register renaming.

In various embodiments, the techniques described herein may be carried out by module 64 using database 68, or it may be distributed between module 64, module 60 and/or other elements of the processor. In the context of the present patent application and in the claims, any and all processor elements that control the pipeline so as to carry out the disclosed techniques are referred to collectively as “control circuitry.”

Processor 20 can be implemented using any suitable hardware, such as using one or more Application-Specific Integrated Circuits (ASICs), Field-Programmable Gate Arrays (FPGAs) or other device types. Additionally or alternatively, certain elements of processor 20 can be implemented using software, or using a combination of hardware and software elements. The instruction and data cache memories can be implemented using any suitable type of memory, such as Random Access Memory (RAM). ROB 44 is typically implemented in a suitable internal volatile memory of the processor.

Processor 20 may be programmed in software to carry out the functions described herein. The software may be downloaded to the processor in electronic form, over a network, for example, or it may, alternatively or additionally, be provided and/or stored on non-transitory tangible media, such as magnetic, optical, or electronic memory.

### Efficient Reorder Buffer (ROB) Management Scheme

In some embodiments, the control circuitry writes instructions into ROB 44 using a write pointer. At any time the write pointer tracks the position of the next instruction to be written into the ROB. The control circuitry increments the write pointer with each instruction being written.

Removal of instructions, which were written using the write pointer, is carried out using two read pointers denoted read1 and read2. Pointer read1 points to the oldest instruction in ROB 44. When the oldest instruction in the ROB is committed, the control circuitry may remove this instruction from the ROB and increment pointer read1 (to again point to the oldest instruction remaining in the ROB, thereby collapsing read1 into read2). Pointer read2 points to another, younger instruction in ROB 44 that is subject to removal. As noted above, both the instruction pointed to by read1 and the instruction pointed to by read2 belong to the same software thread. When removing this instruction, the control circuitry increments pointer read2 to point to the next-oldest instruction.

In some embodiments, the control circuitry marks a certain instruction in the ROB (typically the oldest instruction) with a value HOLE_SIZE that indicates the offset to the next ROB entry. When both read1 and read2 point to the same instruction, no hole exists and HOLE_SIZE=0.

While removal of instructions using read1 is final in the sense that these instructions are committed by the processor, the removal of instructions using read2 is associated with speculative committing. In some cases, it is still possible that an instruction removed using read2 will have to be flushed, because not all the older instructions have been finally committed yet. As such, the control circuitry typically records the architectural state of the processor (e.g., the architectural-to-physical register mapping) corresponding to the instruction pointed to by read2. If at a later stage the hole diminishes, meaning subsequent committal from read2 is final, the control circuitry merges the recorded architectural state with the actual current architectural state of the processor. The record of the architectural-to-physical register mapping for a particular instruction is also referred to as a “checkpoint.”

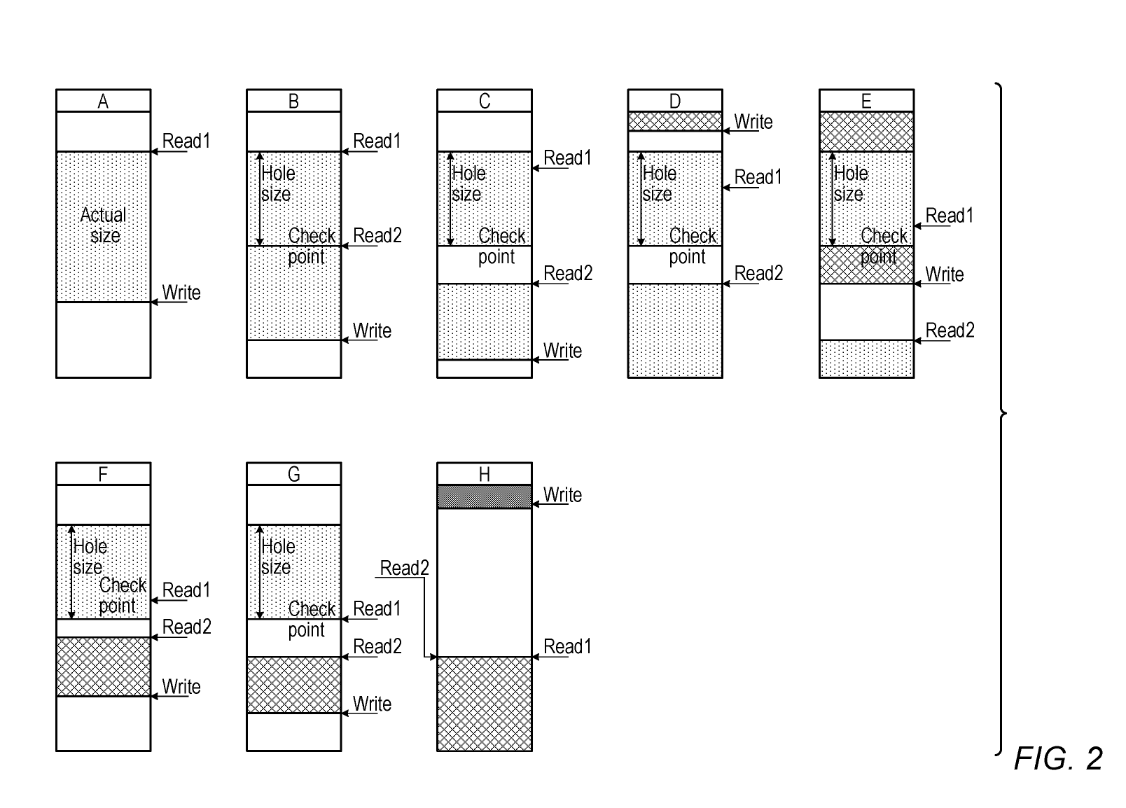

FIG. 2 is a diagram that schematically illustrates a process of managing ROB 44, carried out by the control circuitry of processor 20, in accordance with an embodiment of the present invention. The figure shows the status of ROB 44 at ten successive stages of the process denoted A-J. Throughout this description, writing and reading of instructions is performed in a cyclic manner. On each write/read operation, the appropriate write/read pointer moves down, and when the pointer reaches the lowest part of the ROB diagram it wraps-around to the highest part of the ROB diagram.

Stage A: Initially, at stage A, both read1 and read2 point to the same instruction at the top of the ROB. (Only read1 is shown in the figure for clarity.) In this initial stage, there is no hole, i.e., HOLE_SIZE=0, and all buffered instructions are listed in-order between the location of the write pointer and the location of read1 & read2.

Stage B: At some point in time, the control circuitry decides to start committing and removing instructions from a different location in the ROB using read2. This situation is shown at stage B. Read1 did not move. Read2 points to a different instruction, younger than the instruction pointed to by read1. HOLE_SIZE now has some positive value. In the present example, additional instructions have been written to the ROB between stages A and B, and the write pointer has therefore moved further down.

In various embodiments, the control circuitry may decide to depart from the initial stage and split read2 from read1 in response to various events. In one embodiment, the control circuitry decides to remove instructions using read2 upon detecting that removal of instructions using read1 is stalled. In another embodiment, the control circuitry decides to remove instructions using read2 upon detecting that an architectural-to-physical register mapping is available for the instruction pointed to by read2. Put in another way, the control circuitry detects that the first instruction to which read2 points serves as a recorded checkpoint. In yet another embodiment, any long-latency instruction (e.g., for example, cache miss or Translation-Lookaside Buffer (TLB) miss) can serve as an event. Additionally or alternatively, any other suitable event can be used for triggering the speculative committal and removal of instructions using read2.

In some embodiments, before splitting read2 from read1, the control circuitry verifies continuously that HOLE_SIZE does not exceed some predefined maximal value. The predefined maximal value is typically associated with the ROB size. The rationale behind this limit is that an exceedingly large hole leaves only a small ROB space for subsequent instructions, which may in turn degrade performance.

Stages C-E: In these stages, the control circuitry commits and removes instructions from the ROB using read2, or concurrently using read1 and read2, as appropriate. In some embodiments, in a given clock cycle, the control circuitry decides whether to remove an instruction using read1 or using read2, based on a predefined rule. Any suitable rule can be used for this purpose. In one example embodiment, read1 is given priority over read2 (i.e., as long as read1 is not stalled, remove using read1). In another embodiment, read2 is given priority over read1 (i.e., as long as read2 is not stalled, remove using read2).

In still another embodiment, the control circuitry may apply some fairness criterion so that neither read1 nor read2 are idle for long time periods. Such a criterion may specify, for example, that removal is performed alternately from read1 and read2. Alternatively, any other fairness criterion can be used.

In some embodiments, the control circuitry keeps incrementing read1 to point to the next instruction that can be removed, but defers the actual removal to some later stage. In the figures of stages C-E, for example, it can be seen that the location of read1 advances down the ROB, but the oldest instructions are not removed and HOLE_SIZE remains unchanged. The control circuitry may defer the actual removal of instructions as a design choice. For example, removal can be deferred until read2 or the write pointer catches-up and is about to reach the oldest instruction in the ROB.

Writing of newly-renamed instructions using the write pointer also proceeds. If the write pointer reaches the end of the ROB (the bottom, in the diagrams of FIG. 2), it wraps-around to the beginning of the ROB (the top, in the diagrams of FIG. 2) in the next write (as seen in the transition from stage C to stage D).

In an embodiment, if the write pointer reaches the oldest instruction in the ROB (or the instruction in which read2 split from read1), the control circuitry jumps over this region of the ROB and continues to write the next instructions after the hole. This process is seen at the transition from stage D to stage E. The size of the above-described jump is determined by the recorded value of HOLE_SIZE.

Alternatively, if the read1 pointer also progressed and the associated instructions were removed from the ROB, the write pointer may continue to write inside the hole until it reaches the read1 pointer (making better use of the ROB by using the part of the hole which is no longer used). When the write pointer reaches the read1 pointer, the write pointer jumps over the region of the ROB which is left for the hole and continues to write the next instructions after the hole (essentially dynamically shrinking the hole).

In the latter implementation, as long as not all “old” instructions that are supposed to be read by the read1 pointer are removed, read2 and the write pointer are left with an effectively smaller ROB.

Stage F: In an embodiment, the control circuitry carries out a similar process (of jumping over instructions using HOLE_SIZE) when read2 reaches the oldest instruction in the ROB or the instruction in which read2 split from read1. This process is seen in the transition from stage E to stage F.

Stages G-H: At stage G, read1 reaches the checkpoint, i.e., the bottom of the hole. In response, the control circuitry may now remove the instructions in the hole which were committed by read1 (in case these instruction were only committed and not removed). Furthermore, the control circuitry is free to commit all the instructions that are located after the hole and removed by read2 (previously these instructions were only speculatively committed). Finally the control circuitry sets read1 to be equal to read2, which now both point to the oldest instruction in the ROB. At this stage, the ROB is again contiguous, without a hole, and read1=read2. Apart from a cyclic shift, this situation is similar to that of the initial stage A.

The ROB management process shown in FIG. 2 is an example process, which is chosen for the sake of conceptual clarity. In alternative embodiments, any other suitable process may be used. For example, the control circuitry may read the instructions (which were written using the same write pointer) using any suitable number of read pointers. As such, at a given time the ROB may have two or more holes each having its own HOLE_SIZE value.

In some embodiments, upon detecting branch misprediction in a certain branch instruction, the control circuitry flushes all the instructions in the ROB that are younger than the branch instruction in question. If the branch instruction is located inside the hole, then the instruction following the hole are flushed (including instructions that were already removed from the ROB). Pointer read2 and read1 are again set to point to the same instruction, and processing proceeds normally. The control circuitry typically retains the architectural state of the processor in accordance with read1, thus allowing normal handling of exceptions and interrupts.

In the embodiments described above, ROB 44 is implemented using a suitable contiguous memory. In alternative embodiments, the ROB may be implemented using a linked list. The disclosed techniques are applicable in such an implementation, as well. In these embodiments, each instruction that is buffered in the ROB is stored in a respective entry of the linked list. The processing circuitry holds a pool of free linked-list entries that are available for use.

In a linked-list implementation, the control circuitry typically writes an instruction into the ROB by storing the instruction in a new entry obtained from the pool, adding the new entry to the start of the linked list, and linking it to the entry that was previously the first entry in the list. The control circuitry typically removes an instruction from the ROB by reading and removing an entry, e.g., the last entry at the end of the list. Once read and removed, the entry is cleared and put back in the pool of free entries.

In some embodiments of the present invention, the processing circuitry reads and removes instructions from two (or more) different positions in the linked list (this is the equivalent of removing instructions using two or more read pointers). One of the read positions is at the end of the list, and the other position is internally to the list. Removing an entry from an internal position in the list effectively means cutting the list into two parts, with only one part connected to the beginning of the list. This action is the equivalent of creating a hole in the ROB, with the instructions preceding the hole beginning with a write pointer.

All the techniques and features described above can be adapted in a straightforward manner, mutatis mutandis, to a linked-list implementation of the ROB. It should be noted that any flush in the first linked list (which has no write pointer) also flushes all the instructions from the second linked list, including instructions that were already removed from the second list.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
in a pipeline of a processor, writing instructions of a single software thread that are pending for execution into a reorder buffer (ROB) in accordance with a single write position, and incrementing the single write position to point to a location in the ROB for a next instruction to be written; and
removing the instructions, which were written in accordance with the single write position, from first and second different locations in the ROB, and incrementing the first and second locations.

2. The method according to claim 1, wherein:
writing the instructions comprises storing the instructions in respective memory locations in accordance with a write pointer, and wherein incrementing the single write position comprises incrementing the write pointer; and
removing the instructions comprises reading the instructions from the first and second locations in the ROB in accordance with respective first and second read pointers, and wherein incrementing the first and second locations comprises incrementing the first and second read pointers.

3. The method according to claim 1, wherein the ROB comprises one or more linked-lists, wherein writing the instructions comprises writing a new instruction by adding a new linked-list entry to a beginning of the ROB, and wherein removing the instructions comprises removing an instruction by removing a respective linked-list entry from the ROB.

4. The method according to claim 1, wherein removing the instructions comprises removing at least some of the instructions speculatively.

5. The method according to claim 1, wherein removing the instructions comprises creating at least one unoccupied region in the ROB, preceding the second read location.

6. The method according to claim 5, and comprising marking one of the buffered instructions in the ROB to point to a beginning of the unoccupied region.

7. The method according to claim 6, wherein removing the instructions comprises verifying that the unoccupied region does not exceed a predefined maximum size.

8. The method according to claim 1, wherein the first and second locations are initially the same, and comprising advancing the second location in response to a predefined event.

9. The method according to claim 8, wherein the predefined event comprises a stall in removing the instructions from the first location.

10. The method according to claim 8, wherein the predefined event comprises availability of an architectural-to-physical register mapping for an instruction younger than the instruction at the first location.

11. The method according to claim 1, wherein removing the instructions comprises, in a given cycle, choosing whether to remove an instruction from the first location of from the second location based on a predefined rule.

12. The method according to claim 11, wherein choosing whether to remove the instruction from the first or the second location comprises giving the first location priority in removing the instructions, relative to the second location.

13. The method according to claim 11, wherein choosing the first or the second location comprises giving the second location priority in removing the instructions, relative to the first location.

14. A processor, comprising:
a pipeline comprising a reorder buffer (ROB); and
control circuitry, which is configured to:
write instructions of a single software thread that are pending for execution into the ROB in accordance with a write pointer, and increment the write pointer to point to a location in the ROB for a next instruction to be written; and
remove the instructions, which were written in accordance with the same write pointer, from first and second different locations in the ROB in accordance with respective first and second read pointers, and increment the first and second read pointers to track the first and second locations.

15. The processor according to claim 14, wherein the control circuitry is configured to:
write the instructions in respective memory locations in accordance with a write pointer, and increment the single write position by incrementing the write pointer; and
remove the instructions comprises from the first and second locations in the ROB in accordance with respective first and second read pointers, and increment the first and second locations by incrementing the first and second read pointers.

16. The processor according to claim 14, wherein the ROB comprises one or more linked-lists, and wherein the control circuitry is configured to write a new instruction by adding a new linked-list entry to a beginning of the ROB, and to remove an instruction by removing a respective linked-list entry from the ROB.

17. The processor according to claim 14, wherein the control circuitry is configured to remove at least some of the instructions speculatively.

18. The processor according to claim 14, wherein, in removing the instructions, the control circuitry is configured to create at least one unoccupied region in the ROB, preceding the second read location.

19. The processor according to claim 18, wherein the control circuitry is configured to mark one of the buffered instructions in the ROB to point to a beginning of the unoccupied region.

20. The processor according to claim 19, wherein the control circuitry is configured to verify that the unoccupied region does not exceed a predefined maximum size.

21. The processor according to claim 14, wherein the first and second locations are initially the same, and wherein the control circuitry is configured to advance the second location in response to a predefined event.

22. The processor according to claim 21, wherein the predefined event comprises a stall in removing the instructions from the first location.

23. The processor according to claim 21, wherein the predefined event comprises availability of an architectural-to-physical register mapping for an instruction younger than the instruction at the first location.

24. The processor according to claim 14, wherein the control circuitry is configured to choose, in a given cycle, whether to remove an instruction from the first location of from the second location based on a predefined rule.

25. The processor according to claim 24, wherein the control circuitry is configured to give the first location priority in removing the instructions, relative to the second location.

26. The processor according to claim 24, wherein the control circuitry is configured to give the second location priority in removing the instructions, relative to the first location.
